(19) United States
(12) Patent Application Publication
(10) Pub. No.: US 2020/0113776 A1
(43) Pub. Date: Apr. 16, 2020

(54) SECURITY SYSTEM AND MASSAGE MACHINE INCLUDING SECURITY SYSTEM

(71) Applicant: FAMILY INADA CO., LTD., Osaka (JP)

(72) Inventor: Nichimu Inada, Osaka (JP)

(21) Appl. No.: 16/596,128

(22) Filed: Oct. 8, 2019

(30) Foreign Application Priority Data
Oct. 10, 2018 (JP) 2018-191621

(51) Int. Cl. A61H 23/00; G06K 9/00; G06F 16/535

(52) U.S. Cl. CPC A61H 23/004; G06K 9/00221; A61H 2201/0149; G06F 16/535; A61H 2201/5058; G06K 9/00624

(57) ABSTRACT

A security system includes a massage machine, and an external terminal capable of communicating with the massage machine via a communication network. The massage machine includes a massager that performs massage on a user, a controller that controls the massager, a first detector that detects a motion of a human body or an object and produces first detection data, a storage that stores the first detection data, and a telecommunicator that connects the controller to the communication network. The controller includes an abnormality determinator that determines presence or absence of an abnormality relating to the first detection data in the storage, and an abnormality notifier that notifies the telecommunicator of the abnormality when the abnormality determinator determines that an abnormality is present.

### BACKGROUND OF THE INVENTION

### Field of the Invention

The present invention relates to a security system and a massage machine including the security system.

### Background Art

In the related art, a massage machine has been proposed that can transmit physical information of a person to be treated to a registered transmission destination registered in advance, in addition to a service provider and a communication server via a communication network such as the Internet. A massage machine disclosed in JP-A-2017-217085 is a machine that transmits physical information of a person who uses the massage machine and is to be treated.

### SUMMARY OF THE INVENTION

An object of the present invention is to provide a security system capable of notifying an external terminal of an abnormality in a space where a massage machine is installed, and a massage machine to be included in the security system.

An aspect of the present invention is a security system including a massage machine, and an external terminal capable of communicating with the massage machine via a communication network such as the Internet. The massage machine includes a massager that performs massage on a user, a controller that controls the massager, first detector that detects a motion of a human body or an object and produces a first detection data, a storage that stores the first detection data of the first detector, and a telecommunicator. The controller includes an abnormality determinator that determines presence or absence of an abnormality relating to or based on the first detection data that are stored in the storage, and an abnormality notifier that notifies an abnormality to the telecommunicator of the external terminal when the abnormality determinator determines that an abnormality occurs or is present.

With such a configuration, it is possible to inform the external terminal of an abnormality in the space where the massage machine is installed.

### BRIEF DESCRIPTION OF THE DRAWINGS

FIG. 1 is a diagram showing an overall configuration of a system according to an embodiment of the present invention.

FIG. 2 is a diagram showing a configuration of a massage machine.

FIG. 3 is a schematic diagram showing the configuration of the massage machine.

FIGS. 4A and 4B are block diagrams showing the configuration of the massage machine.

FIG. 5 is a side view for explaining a posture of the massage machine.

FIG. 6 is a diagram showing a configuration of a massage generator.

FIG. 7 is a diagram showing a configuration of a control pad.

FIGS. 8A and 8B are diagrams showing the installation of detectors. FIG. 8A is a diagram showing the installation of a first detector and a second detector in a space where the massage machine is installed, and FIG. 8B is a diagram showing the installation of the first detector in the space where the massage machine is installed and the installation of the second detector in a space where the massage machine is not installed.

FIG. 9 is a flowchart of first abnormality determination.

FIG. 10 is a flowchart of a second abnormality determination.

FIG. 11 is a diagram showing the installation of a third detector at an entrance of the space where the massage machine is installed.

FIG. 12 is a flowchart of first mode switching.

FIG. 13 is a flowchart of second mode switching.

### DETAILED DESCRIPTION OF THE INVENTION

The first detector includes an electronic circuit combined with a motion sensor and produces the first detection data based on the signal produced by the motion sensor based on the motion of a human body or an object. The controller includes an electric circuitry of the abnormality determinator and the abnormality notifier. The external terminal includes an electric circuitry of the telecommunicator.

It is preferable that the motion sensor of the first detector is an infrared sensor including a light emitter and a light receiver, and the light receiver receives light reflected when the light emitter emits light in a predetermined range, and detects a motion of a human body or an object based on a change in a reflected light amount.

With such a configuration, it is possible to detect an abnormality in the space where the massage machine is installed by the infrared sensor.

Further, it is preferable that the first detector has a camera or a video camera, and detects a motion of a human body or an object by comparing a past image captured by the camera in the past with a currently captured image.

With such a configuration, it is possible to detect an abnormality in the space where the massage machine is installed by the camera.

Further, it is preferable that the security system further includes a first image capturer such as a still camera or a video camera that captures images within a range where the first detector performs detection and produces first imaging data, and a storage that stores the first imaging data imaged or captured by the first image capturer, in which the abnormality notifier gives notice of the first imaging data when the abnormality determinator determines that an abnormality occurs or is present.

With such a configuration, it is possible to transmit the captured picture or video to the external terminal owned by the user at the time of notification of an abnormality. For example, it is possible to know the situation of a room where the massage machine is installed by using the picture and the video in more detail.

Further, it is preferable that the security system further includes a sound outputter such as a speaker that outputs sound, in which the controller causes the sound outputter to output sound in a case where the abnormality determinator determines that an abnormality occurs.

With such a configuration, it is possible to warn by sound. For example, it is possible to warn a thief who invades an empty room where the massage machine is installed, with a sound.

Further, it is preferable that the security system further includes a second detector that contains electronic circuitry capable of communicating with the massage machine and detects a motion of a human body or an object in the same space as or a different space from a space where the massage machine is installed, in which the abnormality determinator determines presence or absence of an abnormality relating to the first detection data and/or second detection data of the second detector.

With such a configuration, it is possible to perform detection of an abnormality in higher accuracy in the space where the massage machine is installed. Also, it is possible to detect an abnormality in the space where the massage machine is not installed.

Further, it is preferable that data of one or more persons relating to a part of a user's body for identifying the user is registered in the storage in advance, the security system further includes third detector that is capable of communicating with the massage machine, is provided at an entrance of a space where the massage machine is installed, and detects a part of a user's body, and recognizer that identifies a user based on the data of one or more persons and third detection data detected by the third detector, the massage machine has a massage mode in which a massage is performed on a user by the massager and a security mode in which the abnormality notifier notifies the external terminal of an abnormality, and the controller causes the recognizer to determine the number of persons present in the space, and performs control of switching the mode to the massage mode in a case where it is determined that one or more persons exist in the space, and switching the mode to the security mode in a case where it is determined that no person exists in the space.

With such a configuration, it is possible to determine whether a person exists in the space where the massage machine is installed, and to automatically switch between the massage mode and the security mode.

Further, it is preferable that a massage machine including the security system is provided.

With such a configuration, it is possible to achieve the massage machine that can inform the external terminal of an abnormality in the space where the massage machine is installed.

According to the present invention, it is possible to inform an external terminal of an abnormality in a space where a massage machine is installed. Detailed explanation of the embodiments of the embodiments is described below.

### Overall Configuration of System

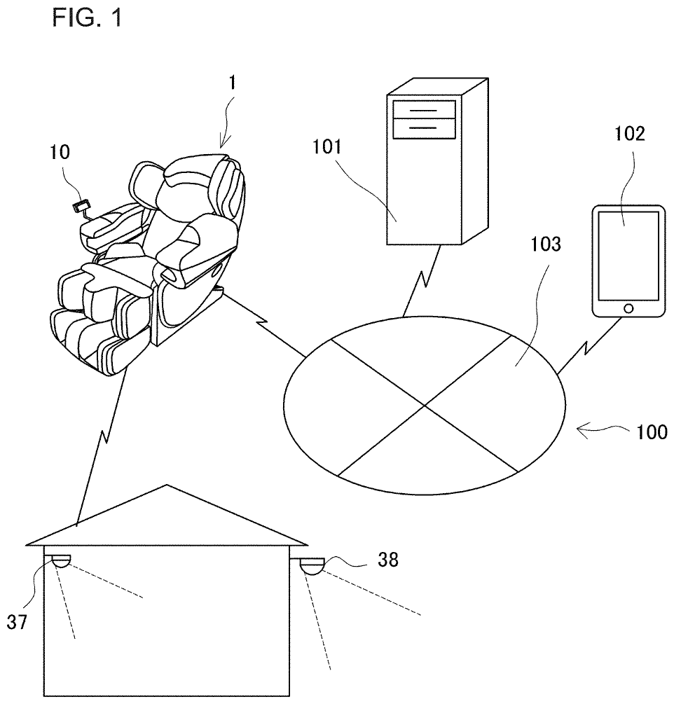

An overall configuration of a system 100 provided with a massage machine 1 according to an embodiment is described based on FIG. 1. The system 100 includes the massage machine 1 installed in a user's home or the like, a cloud-type server 101 installed in a service provider side, and an external terminal 102, such as a cellular phone or a smart phone, owned by the user. The massage machine 1, the server 101, and the external terminal 102 are communicatably connected to one another via a public line network or a WiFi network including the Internet (hereinafter, referred to as a “communication network”) 103. In a space SP1 same as the space SP1 where the massage machine 1 is installed or a space SP2 different from the space SP1, the massage machine 1 is connected to a second detector 37 that includes an electronic circuitry and a motion sensor and detects a human body or an object, or a third detector 38 that includes an electronic circuitry and a motion sensor and is provided at an entrance of the space SP1 where the massage machine 1 is installed and detects a part of user's body so as to be capable of wireless or wired communication. The second detector 37 and the third detector 38 will be described later.

In the present embodiment, a smartphone 102 will be described as an example of the external terminal 102.

The external terminal 102 is not limited to the smartphone 102, and may be an external terminal which is physically separated from the massage machine 1 and can be carried by the user. For example, a tablet terminal may be adopted.

Examples of the above-mentioned service provider include a service provider who lends or sells the massage machine 1, a service provider who manages the sold massage machine 1, and a security company under contract.

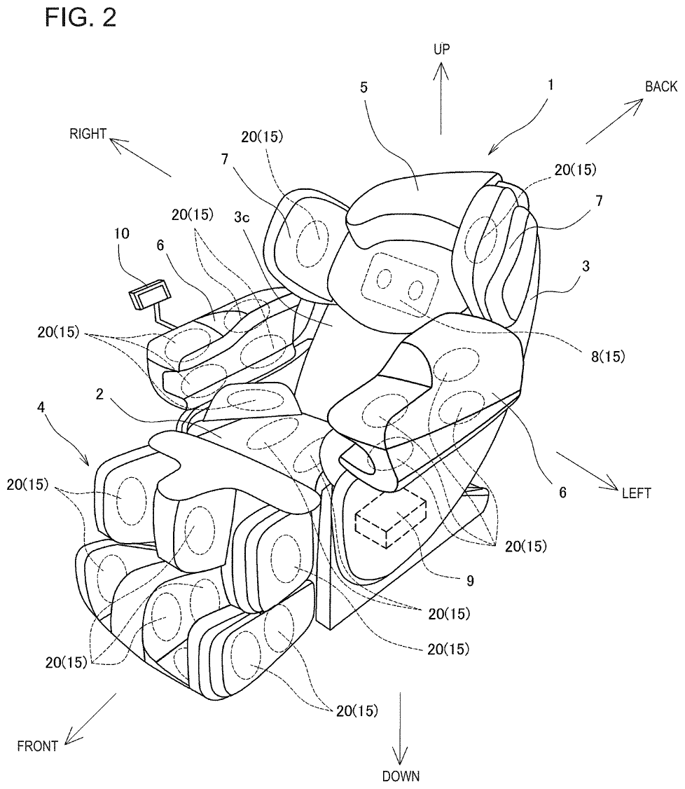

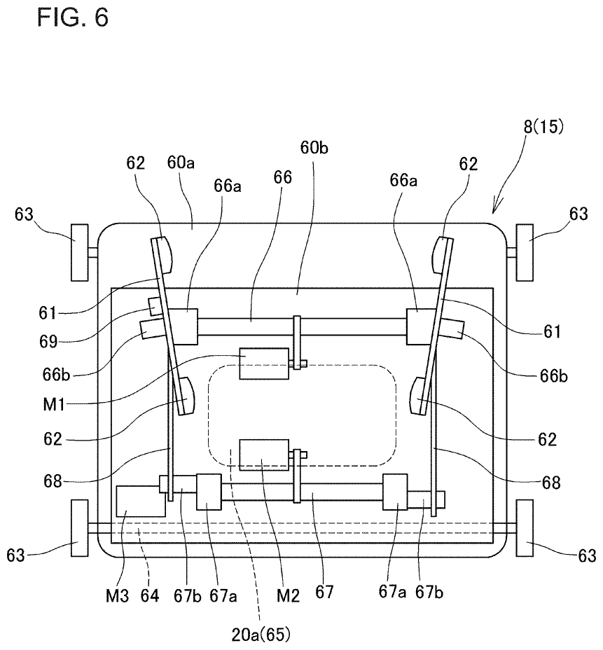

A control pad 10 of the massage machine 1 (FIG. 2 and FIG. 6) and the server 101 can be connected to each other by the communication network 103. The massage machine 1 can be connected to the communication network 103 via Wi-Fi (registered trademark). Also, the server 101 and the smartphone 102 can be connected to each other by the communication network 103. As the communication network 103, for example, an internet network, a network in an area, or the like may be mentioned.

### Configuration of Massage Machine

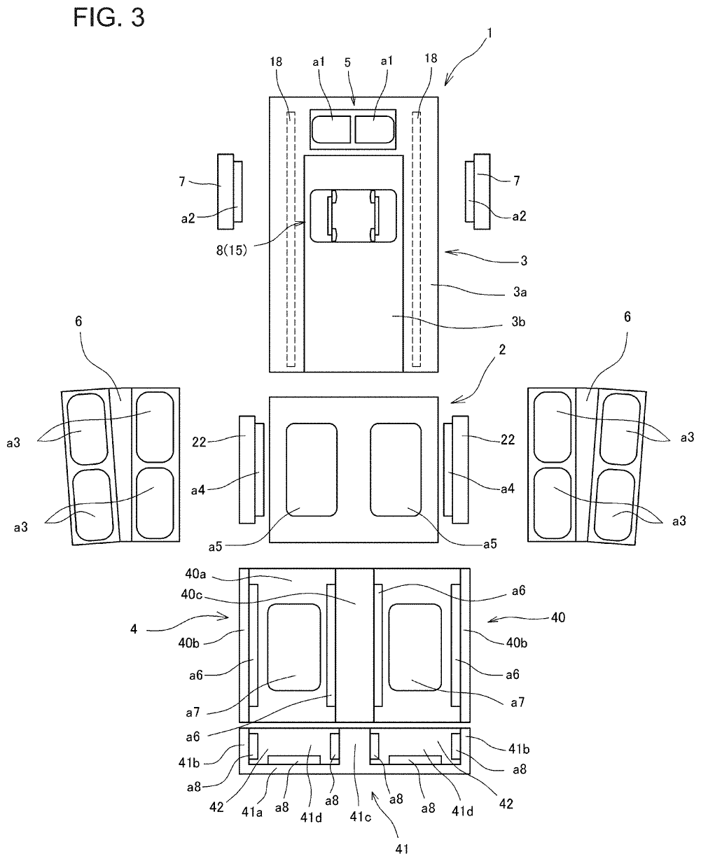

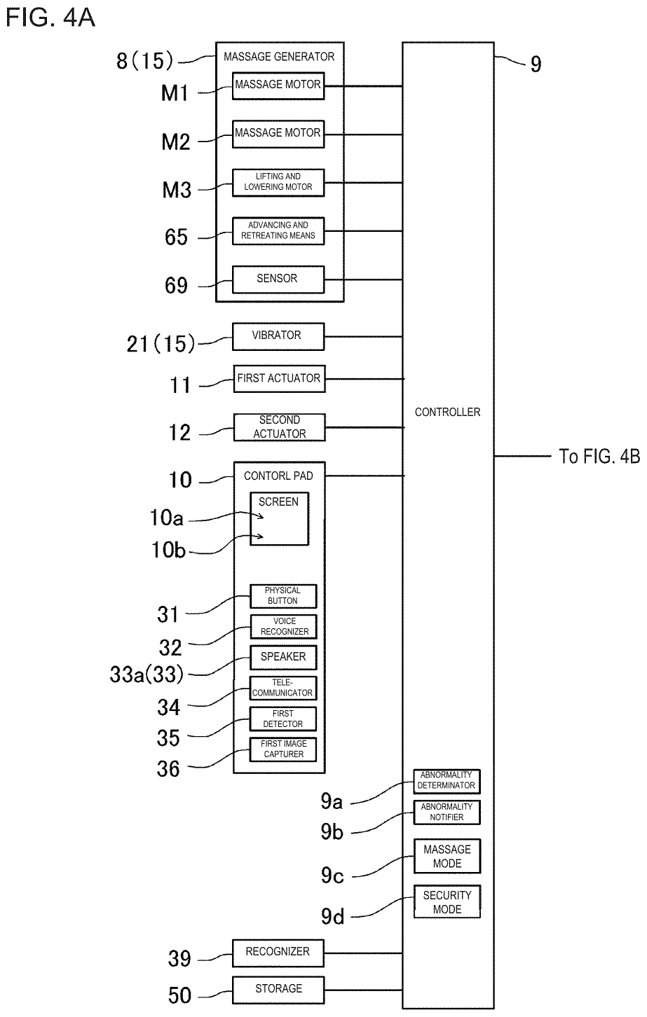

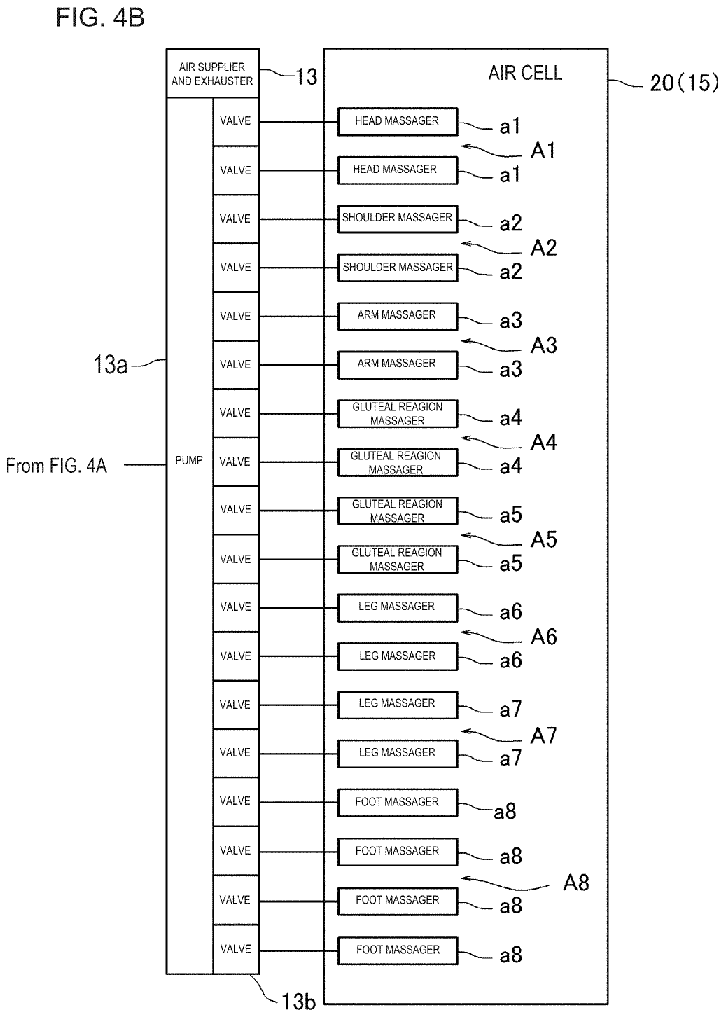

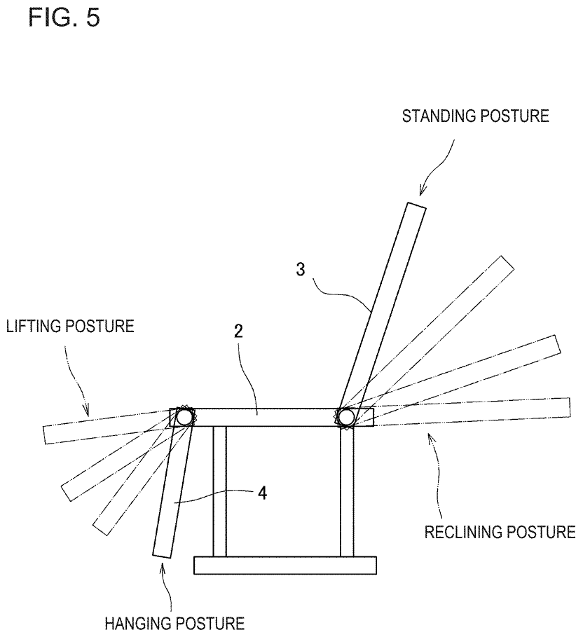

Hereinafter, the massage machine 1 according to the present embodiment is described. FIG. 2 is a front perspective view of the massage machine 1 according to the present embodiment. FIG. 3 is a schematic diagram of a massage machine 1 according to the present embodiment. FIGS. 4A and 4B are functional block diagrams of the massage machine 1. FIG. 5 is a side view for explaining the posture of the massage machine 1. FIG. 6 is a front view of the massage generator 8. In addition, the concept of the direction used by the following description corresponds with the concept of the direction when viewed from the user who sits on the massage machine 1 shown in FIG. 2, and other cases will be described suitably.

Moreover, about the definition of the front and back of the body, a chest side of the user who stands up is a “surface” and a back side of the user is a “back surface”.

### Overall Configuration of Massage Machine

As shown in FIGS. 1 to 4B, the massage machine 1 according to the present embodiment mainly includes a seat 2 that the user sits, a backrest 3 that is provided on a posterior portion of the seat 2 so as to be reclinable and the user leans on, a footrest 4 that is provided on an anterior portion of the seat 2 so as to be swingable up and down and supports a lower limb of the user, a pillow 5 that is provided on upper front surface of the backrest 3 and supports a head and/or neck of the user, an armrest 6 provided on both the right and left sides of the seat 2, and side walls 7 provided on both the right and left sides of the backrest 3. The seat 2, the backrest 3, the footrest 4, the pillow 5, and the armrest 6 are function as a body supporter that supports the user's body. At 2 to 6 places of the body supporters, a massager 15 configured by an air cell 20 that performs massage on the user's body described later or a vibrator 21 described later is provided. Also, the massage machine 1 includes, on the backrest 3, a massage generator 8 as the massager 15 that performs kneading massage and/or tapping massage, the controller 9 that controls each operation of the massage machine 1, and the control pad 10 that causes the user to perform each operation described later.

As shown in FIGS. 2, 4A and 4B, and 5, the backrest 3 is configured to be reclinable back and forth relative to the seat 2 by a first actuator 11 (refer to FIGS. 4A and 4B) provided under the seat 2, and is changeable from a standing posture shown in FIG. 2 to a reclining posture (refer to FIG. 5) in which the backrest surface is substantially horizontal. The armrest 6 is configured to move rearward in conjunction with the reclining of the backrest 3 and move forward in conjunction with the standing up of the backrest 3. The footrest 4 is configured to be swingable up and down relative to the seat 2 by a second actuator 12 (refer to FIGS. 4A and 4B) provided under the seat 2, and is changeable from a hanging posture shown in FIG. 2 to an lifting posture (refer to FIG. 5) in which the thigh and the foot are supported with a straight knee.

As shown in FIGS. 3 to 4B, under the seat 2, an air supplier and exhauster 13 that supplies and exhausts air with respect to respective massagers a1 to a8 including the air cell 20 and has a pump 13a and a valve 13b, and the controller 9 described above are provided. The vibrator 21 driven by the motor may be provided at the same position as each of the massagers a1 to a8. The air cell 20 can press the user by supplying and exhausting air. The vibrator 21 can apply vibration to the user by rotation of the eccentric weight. The controller 9 has a programmable microcomputer or the like, and drives and controls the respective actuators 11 and 12, the massager 15, and the air supplier and exhauster 13. The controller 9 is electrically connected to the control pad 10 described later or a storage 50 that stores first detection data 35a of the first detector 35 that detects a motion of a human body or an object described later.

The massage machine 1 operates the massager 15 according to a predetermined program (massage course) stored in the storage 50, and also operates according to an instruction from the control pad 10 by the user described later.

### Configuration of Seat

As shown in FIGS. 2 to 4B, walls 22 provided facing the outer side surface of the gluteal region and/or the femoral region of the user are provided on both the right and left sides of the seat 2. The walls 22 are erected on the side of the seat. A gluteal region massager a4 which massages the outer side surface of the gluteal region and/or the femoral region is provided in the inner side surface of the wall 22. An inner side wall of the armrest 6 each provided on both the right and left sides of the seat 2 may be used as the wall 22, and the gluteal region massager a4 may be provided on the inner side wall of the armrest. Moreover, the gluteal region massager a5 which massages a user's the gluteal region and/or the femoral region from below (the back surface) may be provided in the seat 2. The gluteal region massagers a4 and a5 are configured by the air cell 20 that is expanded and contracted by air supply and exhaust. As described above, the gluteal region massagers a4 are paired with each other on the right and left sides to constitute a massager group A4, and the gluteal region massagers a5 are paired with each other on the right and left to constitute a massager group A5.

### Configuration of Backrest

As shown in FIGS. 2 to 4B, the backrest 3 is configured by a hard back frame 3a, a guide rail 18 that guides lifting and lowering of the massage generator 8 that is the massager 15 assembled to the back frame 3a, and a cover 3c that covers the back frame 3a. The back frame 3a is configured by metal and/or resin. In addition, the back frame 3a has an opening 3b that is formed at the center in the right and left direction and opens in the front and back direction, and has a substantially portal shape in a front view. Also, the cover 3c covers the opening 3b from the front. A treater 62 (refer to FIG. 6) of the massage generator 8 protrudes forward from the opening 3b, and is configured to massage the body of the user from behind via the cover 3c.

### Configuration of Massage Generator

Hereinafter, the configuration of the massage generator 8 will be described.

As shown in FIGS. 2 to 4B and 6, the massage generator 8 to massage an upper body of the user from the behind (the back surface) is provided in the backrest 3. A plurality of massage generators 8 (one in the present embodiment) may be provided along a height direction. The massage generator 8 is configured by an arm 61 being paired with each other on the right and left sides and the treater 62 each provided on the upper and lower ends of the arm 61, and can perform kneading massage that the right and left treaters 62 approach and separate by driving the massage motors M1 and M2 and tapping massage that the right and left treaters 62 alternately advance and retract to the user side. In addition, the massage generator 8 can move upward or downward along the height direction by driving the lifting and lowering motor M3 to change the position with respect to the body or perform rolling massage. The back frame 3a is provided with a pair of guide rails 18 extending in the height direction and being paired with each other on the right and left sides, and the massage generator 8 moves along the guide rails 18. Since the massage generator 8 can move in the height direction, the treater 62 can massage between the neck and the waist of the user.

As shown in FIG. 6, the massage generator 8 includes a base frame 60a and a movable frame 60b supported by the base frame 60a. The base frame 60a includes guide rollers 63 fitted to the guide rails 18 on both the right and left sides thereof. Also, the base frame 60a can move along the height direction by an elevator (not shown) including a rack and pinion or the like. The movable frame 60b is supported by the base frame 60a via a swing shaft 64 in a lateral direction. Advancing and retreating means 65 including the air cell 20a is provided between the base frame 60a and the movable frame 60b. The air cell 20a that is advancing and retreating means 65 can be expanded and contracted to advance and retract the movable frame 60b in the front and back direction around the swing shaft 64, and the specific part of the user can be advanced and retracted. The movable frame 60b may not be advanced and retracted, and alternatively, a structure may be adopted in which the arm 61 is provided with the advancing and retreating means 65 to advance and retract only the arm 61.

The arm 61 is connected to a kneading shaft 66 and a tapping shaft 67 extending in the lateral direction. Inclination cam 66a having an inclined shaft 66b are provided on both the right and left sides of the kneading shaft 66, and the arm 61 is attached to the inclination cam 66a. The right and left inclined shafts 66b are inclined with respect to the axial center of the kneading shaft 66 so as to have a substantially truncated chevron shape in a front view. An eccentric cam 67a having eccentric shaft 67b eccentric to the axial center of the tapping shaft 67 is provided on both the right and left sides of the tapping shaft 67 and the arm 61 is attached to the eccentric cams 67a via a connecting rod 68. The phases of the right and left eccentric shafts 67b with respect to the axial center of the tapping shaft 67 are different from each other, and specifically, differ by 180 degrees. The kneading shaft 66 and the tapping shaft 67 are rotated by the driving of the massage motors M1 and M2, respectively. The treater 62 performs kneading massage by rotation of the kneading shaft 66 and performs tapping massage by rotation of the tapping shaft 67. The arm 61 provided with the treater 62, the kneading shaft 66, and the tapping shaft 67 are supported by the movable frame 60b. Therefore, the treater 62 can advance and retract relative to the user through the movement of the movable frame 60b.

The arm 61 is swingable in the front and back direction, and is biased by biasing means (not shown) such as a spring so that the upper treater 62 protrudes forward. Moreover, the massage generator 8 has a sensor 69 that is detection means which detects the specific part of the user's body. The sensor 69 can obtain physical information by detecting that the arm 61 reaches a predetermined swing position. Specifically, in the process of lifting the massage generator 8 along the height direction, when the upper treater 62 reaches the upper portion of the shoulder, the load acting on the treater 62 is released, and the arm 61 swings forward to reach a predetermined swing position. The sensor 69 detects that the arm 61 reaches a predetermined swing position, and detects a shoulder position based on a vertical position of the massage generator 8 at that time. Based on the shoulder position, the positions of other parts (a neck, a back, a waist, and the like) are obtained by calculation. The detected physical information is stored in the storage 50. Accordingly, it is possible to perform massage on a specific part of the user (a neck, a shoulder, a back, a waist, and the like).

### Configuration of Side Wall

As shown in FIGS. 2 to 4B, the side walls 7 are provided on both the right and left sides of the back frame 3a (the backrest 3) so as to face the outer side surface of the shoulder or an upper arm of the user. The side walls 7 are erected forward on the side of the backrest 3. Shoulder massager a2 that massage the outer side surface of the shoulder or the upper arm are provided on the inner side surfaces of the side walls 7. The shoulder massager a2 is configured by the air cell 20 that is expanded and contracted by air supply and exhaust. As described above, the shoulder massagers a2 are paired with each other on the right and left sides to constitute a massager group A2.

### Configuration of Pillow

As shown in FIGS. 2 to 4B, the pillow 5 that supports the head and/or the neck of the user is provided on the upper front surface of the backrest 3. Head massagers a1 that are provided to face the rear surface of the head and/or the neck and are paired with each other are provided on the front surface of the pillow 5. The head massagers a1 are configured by the air cell 20 that is expanded and contracted by air supply and exhaust. As described above, the head massagers a1 are paired with each other on the right and left sides to constitute a massager group A1. The head massagers a1 may be provided to face the outer side surface of the head and/or the neck. In this case, the head massagers a1 may be provided on the inner side surface of the wall (not shown) erected forward. Also, the head massagers a1 may be provided directly on the upper front surface of the backrest 3 instead of the pillow 5.

### Configuration of Armrest

As shown in FIGS. 2 to 4B, armrests 6 that support the user's hands and the forearm are provided on both the right and left sides of the seat 2. Arm massager a3 are provided on the armrests 6 in a vertical direction of the hand and the forearm. The arm massager a3 is configured by the air cell 20 that is expanded and contracted by air supply and exhaust. As described above, the arm massagers a3 are paired with each other on the right and left sides to constitute a massager group A3.

### Configuration of Footrest

As shown in FIGS. 2 to 4B, the footrest 4 includes a pair of right and left leg supporters 40 that support the thigh of the user and a pair of right and left foot supporters 41 that support the foot of the user. The leg supporters 40 have bottom walls 40a provided to face the back surface of the thigh of the user and side walls 40b erected forward from the right and left ends of the bottom wall 40a, and a central wall 40c erected forward from the center between the right and left bottom walls 40a.

Leg massager a6 that massage the outer side surface of the thigh are provided on the inner side surfaces of the side walls 40b. The leg massagers a6 that massage the inner side surface of the thigh are provided on both outer side surfaces of the central walls 40c. The leg massagers a7 that massage the back surface of the thigh of the user are provided in the bottom wall 40a. The leg massagers a6 and a7 are configured by the air cell 20 that is expanded and contracted by air supply and exhaust. The leg massagers a6 are provided such that the leg massager a6 facing the inner side surface of the thigh is paired with the leg massager a6 facing the outer side surface of the thigh on the right and left sides to constitute a massager group A6. The leg massagers a7 are provided such that the leg massager a7 facing the back surface of the thigh on the left side across the central wall 40c is paired with the leg massager a7 facing the back surface of the thigh on the right side across the central wall 40c on the right and left sides to constitute a massager group A7.

Each of the foot supporters 41 has a bottom wall 41a on which the foot of the user is placed, a side wall 41b erected upward from the right and left sides of the bottom wall 41a, and a back wall 41d facing the back surface of the foot (in the vicinity of the heel) erected upward from the posterior portion of the bottom wall 41a, and the foot supporters 41 include a central wall 41c erected upward from the right and left sides of the bottom wall 41a. Recesses 42 opened upward and forward of the walls 41a to 41d are formed in the foot supporters 41, and the foot can be accommodated in the recess 42.

Each of the walls 41a to 41c is provided with foot massagers a8 that massage the foot of the user and the foot massagers a8 are paired with each other to constitute a massager group A8. The foot massager a8 is configured by the air cell 20 that is expanded and contracted by air supply and exhaust.

### Configuration of Control Pad

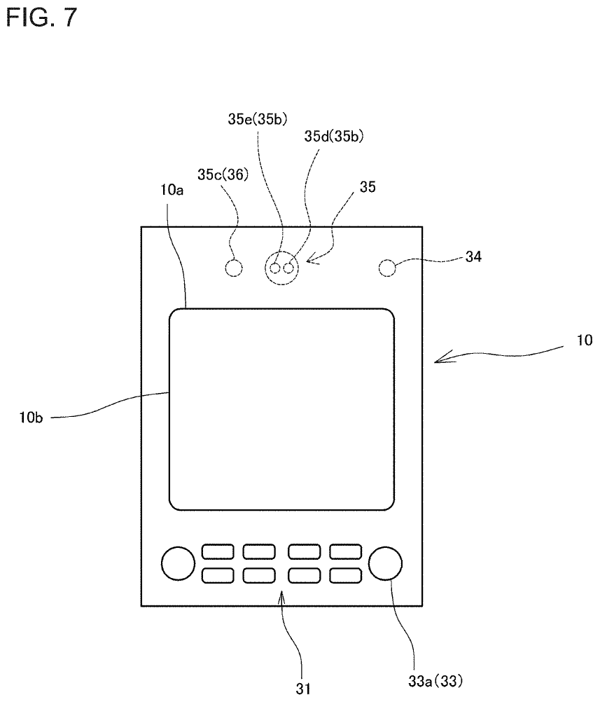

As shown in FIGS. 1, 2, 4A, 4B and 7, the control pad 10 is provided on the upper portion of the armrest 6, so that the user can operate the control pad while sitting. The control pad 10 includes a screen 10a that the user can visually check, a touch panel 10b that the user operates on the screen 10a with a fingertip, and a speaker 33a that is a sound outputter 33 that outputs the display content of the screen 10a or sound. It is described that the speaker 33a is included in the control pad 10, but the configuration is not limited thereto, the speaker 33a may be provided on the upper portion of the backrest 3 described above (around the ear when the user sits) or the pillow 5 described above. Further, the user operates the control pad 10 to recline the backrest 3 and change the posture and to swing the footrest 4 up and down and change the posture. In addition, it is possible to select the massage generator 8 to be operated and each of the massagers a1 to a8, or change the operation (technique or strength) of the massage generator 8 and each of the massagers a1 to a8. Instead of the operation by the touch panel 10b, only the operation by the voice recognizer 32 using only a physical button 31 disposed in the control pad 10 or a microphone (not shown) installed in the control pad 10 may be adopted. Accordingly, the user can easily perform select. The microphone (not shown) that is the voice recognizer 32 may be installed in the upper portion of the backrest 3 or the pillow 5 instead of in the control pad 10. Accordingly, the user can perform select by the voice recognizer 32 while leaning on the backrest 3 without changing the posture.

The control pad 10 includes the first detector 35 that faces the opposite direction of the massage machine 1 and detects a motion of a human body or an object, first image capturer 36 that images a range that the first detector 35 performs detection, and a telecommunicator 34 that communicates with second detector 37 detecting a motion of a human body or an object or third detector 38 provided at the entrance of the space SP1 where the massage machine 1 is installed and detecting a part of the user's body, in the space SP1 same as the space SP1 where the massage machine 1 is installed or the space SP2 different from the space SP1. The telecommunicator 34 has a receiver (an antenna) that receives radio waves in a predetermined frequency band and is installed inside the control pad 10. In a case where the second detector 37 and the third detector 38 are present in a communicatable range of the telecommunicator 34 included in the control pad 10, the massage machine 1 can communicate with the second detector 37 or the third detector 38. The telecommunicator 34 communicates with the smartphone 102 owned by the user via the communication network 103 such as the Internet, so that the massage machine 1 can communicate with the external terminal 102.

### Configuration of First Detector

It is preferable that the first detector 35 that detects a motion of a human body or an object and the first image capturer 36 that images a range that the first detector 35 performs detection are provided on the opposite side, that is, a back side of the screen 10a of the control pad 10 and to face the opposite direction of the massage machine 1. In the present embodiment, the first detector 35 and the first image capturer 36 are provided on the back surface and the upper portion of the control pad 10. Accordingly, since the massage machine 1 is usually installed in the corner of the room, not in the center of the room, it is possible to detect or image a motion of a human body or an object from the corner of the room to the center of the room, and thus it is possible to detect or image a wide range. Furthermore, in a case where the massage machine 1 has a structure that the direction of the control pad 10 itself can be changed, it is possible to adjust a detection range or an imaging range.

It is preferable that the first detector 35 is an infrared sensor 35b including a light emitter 35d and a light receiver 35e of infrared light. The light receiver 35e receives light reflected when the light emitter 35d emits infrared light in a predetermined range. The reflected light amount is a predetermined value in a case where a motion of a human body or an object is not present in a predetermined range, however the reflected light amount changes in a case where a motion of a human body or an object is present and a human body or an object enters in the predetermined range. A motion of a human body or an object can be detected based on the change in the reflected light amount. Accordingly, the first detector 35 can detect a motion of a human body or an object. That is, it is possible to detect a motion of a human body or an object based on a value of the first detection data 35a of the first detector 35.

The first detector 35 may be a camera 35c in addition to the infrared sensor 35b described above. It is preferable that the camera 35c is a camera using an imager such as CCD or CMOS. It is possible to detect a motion of a human body or an object by comparing a past image captured by the camera 35c in the past with a current image that is currently captured. For example, a part of images is different between an image (a past image) obtained by imaging an object (furniture) fixed in the room and an image (a current image) in which a human body or an object enters in front of or in the vicinity of the fixed object. It is possible to detect a motion of a human body or an object by comparing values of color data (RGB) at different locations with each other.

### Configuration of First Image Capturer

It is preferable that the first image capturer 36 is the camera 35c described above as the first detector 35. First imaging data 36a imaged by the first image capturer 36 is stored in the storage 50. Further, in a case where an abnormality determinator 9a described later determines that an abnormality occurs, an abnormality notifier 9b described later can give notice of the first imaging data 36a to the external terminal 102. Accordingly, the first imaging data 36a that is imaged can be transmitted to the external terminal 102 owned by the user at the time of notification of an abnormality. For example, it is possible to know a detailed situation of the room where the massage machine 1 is installed at the time of an abnormality with a picture or a video.

As shown in FIGS. 4A and 4B, the controller 9 includes the abnormality determinator 9a that determines the presence or absence of an abnormality relating to the first detection data 35a of the first detector 35, and the abnormality notifier 9b that notifies the external terminal 102 of an abnormality by the telecommunicator 34 in a case where the abnormality determinator 9a determines that an abnormality occurs. The abnormality determinator 9a determines the presence or absence of an abnormality relating to the first detection data 35a detected by the infrared sensor 35b or the camera 35c that are the first detector 35. In a case of the infrared sensor 35b, it is determined that an abnormality occurs, when a motion of a human body or an object is detected based on the change in the reflected light amount, and it is determined that an abnormality does not occur, when a motion of a human body or an object is not detected. In a case of the camera 35c, it is determined that an abnormality occurs, when a motion of a human body or an object is detected by comparing the past image with the current image, and it is determined that an abnormality does not occur when a motion of a human body or an object is not detected.

The abnormality notifier 9b notifies the external terminal 102 owned by the user of an abnormality from the telecommunicator 34 in a case where the abnormality determinator 9a determines that an abnormality occurs. As a notification method, a text such as “an abnormality is detected in a room” may be transmitted by the mail function, or an image or a video of the first imaging data 36a imaged by the camera 35c that is the first image capturer 36 may be transmitted. Accordingly, it is possible to notify the external terminal 102 owned by the user of an abnormality while being out, and the user can know the abnormality and can immediately respond. Further, in a case where the abnormality determinator 9a determines an abnormality occurs, the abnormality notifier 9b may notify the external terminal 102 owned by the user of an abnormality and may notify the server 101 of an abnormality. As described above, since the service provider can also know an abnormality by notifying the server 101 of an abnormality, the service provider can notify the security company of an abnormality. The security company can know an abnormality and go to the scene.

In a case where the abnormality determinator 9a determines that an abnormality occurs, the controller 9 may output a warning sound or voice from the speaker 33a that is the sound outputter 33 of the control pad 10. Accordingly, it is possible to warn by sound. For example, it is possible to warn the thief who invades the empty room in which the massage machine 1 is installed, by sound.

Configuration of Second Detector

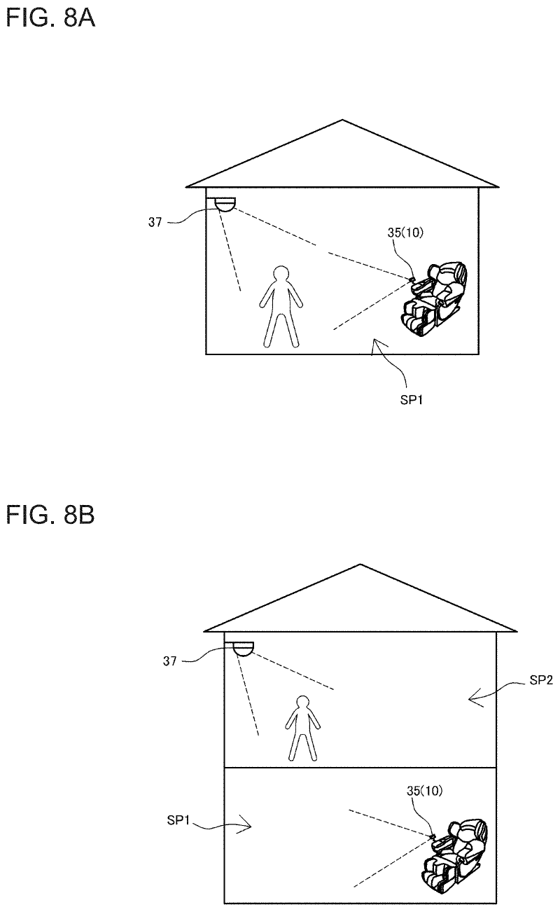

FIGS. 8A and 8B are diagrams showing the installation of the second detector 37. FIG. 8A is a diagram showing the installation of the first detector 35 and the second detector 37 in the space SP1 where the massage machine 1 is installed, and FIG. 8B is a diagram showing the installation of the first detector 35 in the space SP1 where the massage machine 1 is installed and the installation of the second detector 37 in the space SP2 where the massage machine 1 is not installed.

As shown in FIGS. 1 and 8, the second detector 37 that can communicate with the massage machine 1 and detects a motion of a human body or an object in the space SP1 same as the space SP1 (a room) where the massage machine 1 is installed (FIG. 8A) or the space SP2 different from the space SP1 (a room) where the massage machine 1 is installed (FIG. 8B) is provided. It is preferable that the second detector 37 is the infrared sensor 35b or/and the camera 35c that are the first detector 35 described above. The second detection data 37a detected by the second detector 37 is stored in the storage 50, and the abnormality determinator 9a determines the presence or absence of an abnormality relating to the second detection data similarly to the determination of the first detection data 35a. In a case where the second detector 37 is provided in the space SP1 same as the space SP1 where the massage machine 1 is installed of FIG. 8A, it is possible to detect an abnormality in a wide range made up for a range where the first detector 35 cannot perform detection, by the second detector 37. It is possible to perform comprehensive determination of an abnormality based on the detection of the first detector 35 and the second detector 37 and perform highly accurate detection. In a case where the second detector 37 is provided in the space SP2 different from the space SP1 where the massage machine 1 is installed of FIG. 8B, it is possible to detect an abnormality in the space SP2 where the massage machine 1 is not installed, by the second detector 37. It is possible to perform comprehensive determination of an abnormality based on the detection of the first detector 35 and the second detector 37 and perform highly accurate detection.

### Configuration of Mode

As shown in FIGS. 4A and 4B, in the present embodiment, the controller 9 of the massage machine 1 has two modes of a massage mode 9c and a security mode 9d, and the control method of the massage machine 1 differs depending on each mode. The massage mode 9c is a mode in which the massager 15 performs massage on the user, and the user can normally use the massage machine 1 while sitting on the massage machine 1. In the massage mode, the abnormality determinator 9a does not determine the presence or absence of an abnormality.

The security mode 9d is a mode in which the abnormality notifier 9b notifies the external terminal 102 owned by the user of an abnormality in a case where the abnormality determinator 9a determines that an abnormality occurs.

### Flow of Abnormality Determination

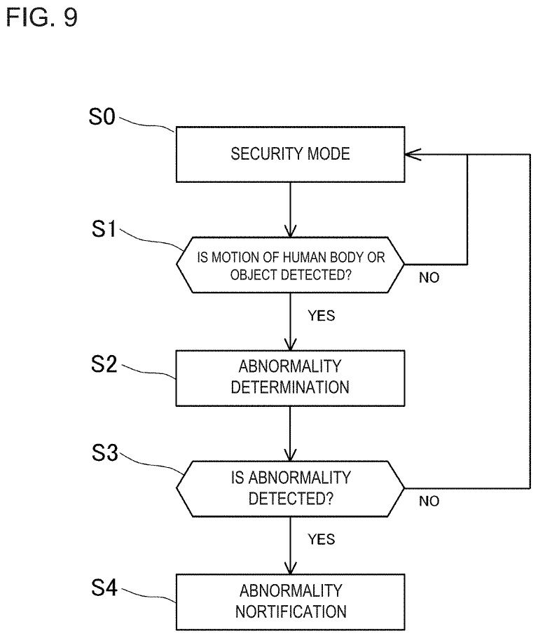

Hereinafter, a flow of a first abnormality determination will be described based on FIG. 9. The first abnormality determination is a flow of the abnormality determination by the first detector 35 in the space SP1 where the massage machine 1 is installed.

The flow of the first abnormality determination will be described with an example of a case where the massage machine 1 is in the security mode 9d (step S0). First, in the space SP1 where the massage machine 1 is installed, the first detector 35 detects whether a motion of a human body or an object is present in a predetermined range (step S1). In a case where it is determined that a motion of a human body or an object is not present in a predetermined range, the process returns to step S0, and in a case where it is determined that a motion of a human body or an object is present in a predetermined range, the process proceeds to the abnormality determination (step S2). The abnormality determinator 9a determines the presence or absence of an abnormality relating to the first detection data 35a of the first detector 35 (step S3). Specifically, in a case where a normal motion of a human body or an object is not present, the infrared sensor 35b detects the reflected light amount in a predetermined range for a predetermined value, and in a case where a motion of a human body or an object is present, the infrared sensor 35b detects the reflected light amount in a predetermined range for a value different from a predetermined value. It is determined that an abnormality occurs by collating a predetermined value with a value different from the predetermined value. In a case where the first detector 35 is the camera 35c, by comparing the past image with the current image, it is determined that an abnormality occurs in a case where a motion of a human body or an object is detected, and it is determined that an abnormality does not occur in a case where a motion of a human body or an object is not detected. In step S3, in a case where it is determined that an abnormality does not occur, the process returns to step S0, in a case where it is determined that an abnormality occurs, the process proceeds abnormality notification (step S4). The abnormality notifier 9b notifies the external terminal 102 owned by the user of an abnormality by the telecommunicator 34. Specifically, a text such as “an abnormality is detected in a room” is transmitted by the mail function to the smartphone 102 owned by the user. An image or a video imaged by the first image capturer 36 such as a still image camera or a video camera may be transmitted to the smartphone 102 owned by the user.

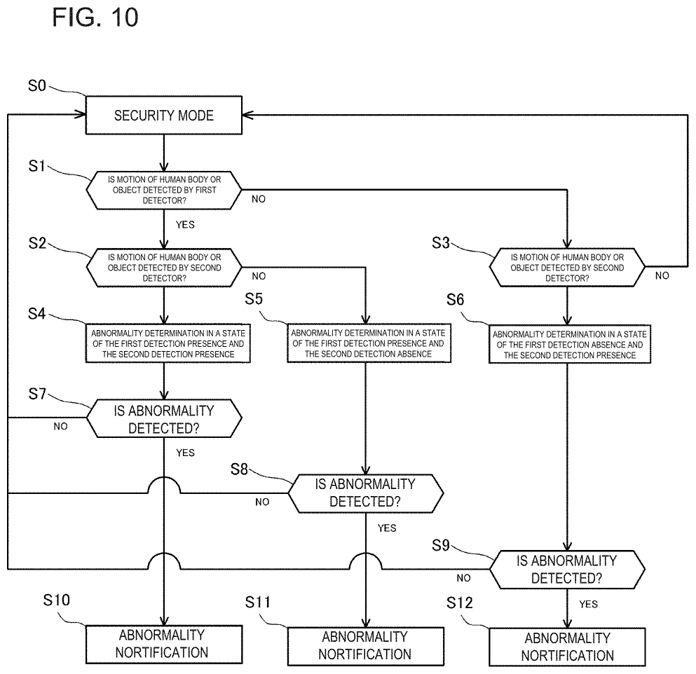

Hereinafter, a flow of second abnormality determination will be described based on FIG. 10. The second abnormality determination is a flow of the abnormality determination by the first detector 35 and the second detector 37 in the space SP1 where the massage machine 1 is installed (refer to FIG. 8A). In the present embodiment, the first detector 35 will be described as the infrared sensor 35b and the second detector 37 will be described as the camera 35c.

The flow of the first abnormality determination will be described with an example of a case where the massage machine 1 is in the security mode 9d (step S0). First, in the space SP1 where the massage machine 1 is installed, the first detector 35 detects whether a motion of a human body or an object is present in a predetermined range (step S1). In step S1, in a case where it is determined that a motion of a human body or an object is not present in a predetermined range, the process proceeds to step in which the second detector 37 detects whether a motion of a human body or an object is present in a predetermined range (step S3), and in a case where it is determined that a motion of a human body or an object is present in a predetermined range, the process proceeds to step in which the second detector 37 detects whether a motion of a human body or an object is present in a predetermined range (step S2). In step S2, in a case where it is determined that a motion of a human body or an object is not present in a predetermined range, the process proceeds abnormality determination in a state of the first detection presence and the second detection absence (step S5), and in a case where it is determined that a motion of a human body or an object is present in a predetermined range, the process proceeds abnormality determination in a state of the first detection presence and the second detection presence (step S4). In step S3, in a case where it is determined that a motion of a human body or an object is not present in a predetermined range, the process returns to step S0 because it is in a state of the first detection absence and the second detection absence, and in a case where it is determined that a motion of a human body or an object is present in a predetermined range, the process proceeds abnormality determination in a state of the first detection absence and the second detection presence (step S6).

Each step of steps S4 to S6 proceeds to step in which the presence or absence of an abnormality relating to the first detection data 35a of the first detector 35 and the second detection data 37a of the second detector 37 is determined (steps S7 to S9). The determination of the presence or absence of an abnormality is performed based on the detection data of the infrared sensor 35b or the camera 35c which are described above. In step S7, it is determined that an abnormality does not occur, the process returns to step S0, it is determined that an abnormality occurs, the process proceeds to the abnormality notification (step S10). In step S8, it is determined that an abnormality does not occur, the process returns to step S0, it is determined that an abnormality occurs, the process proceeds to the abnormality notification (step S11). In step S9, it is determined that an abnormality does not occur, the process returns to step S0, it is determined that an abnormality occurs, the process proceeds to the abnormality notification (step S12).

Since a motion of a human body or an object in the space SP1 where the massage machine 1 is installed is detected based on the first detection data 35a of the infrared sensor 35b and the second detection data 37a of the camera 35c, in step S10, the abnormality notifier 9b can give notice to the external terminal 102 by the telecommunicator 34 based on two types of detection data. For example, it is possible to detect whether a thing operating in a range of the first detection data 35a of the infrared sensor 35b is a human body or an object based on the second detection data 37a of the camera 35c, and to notify and inform a comprehensive abnormality in which an image or a video is combined with a text or a detailed abnormality of the smartphone 102 owned by the user. In step S11, since a motion of a human body or an object in the space SP1 where the massage machine 1 is installed detected based on the first detection data 35a of the infrared sensor 35b, it is possible to notify and inform, by a text, an abnormality in the space SP1 where the massage machine 1 is installed, of the smartphone 102 owned by the user. Further, in step S12, since a motion of a human body or an object in the space SP1 where the massage machine 1 is installed detected based on the second detection data 37a of the camera 35c, it is possible to notify and inform, by an image or a video, an abnormality in the space SP1 where the massage machine 1 is installed, of the smartphone 102 owned by the user. Specifically, a text such as “an abnormality is detected in a room” is transmitted by the mail function to the smartphone 102 owned by the user. An image or a video imaged by the first image capturer 36 may be transmitted to the smartphone 102 owned by the user.

### Configuration of Third Detection Means

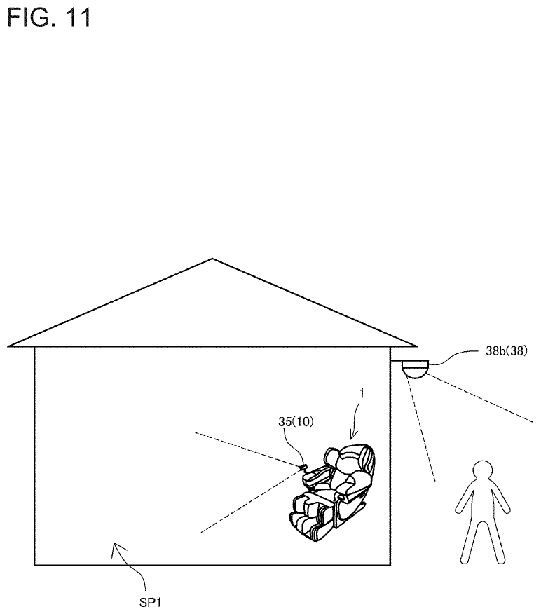

FIG. 11 is a diagram showing the third detector 38 installed at an entrance of a space SP1 where the massage machine 1 is installed.

As shown in FIG. 11, the third detector 38 that can communicate with the massage machine 1 and detects a part of the user's body at the entrance of the space SP1 where the massage machine 1 is installed is provided. In the present embodiment, it is preferable that the third detector 38 is a camera 38b. For example, the camera 38b is installed in front of the entrance of the space SP1 (for example, at a door), and images a part of a body (for example, a face) of a person which passes through the entrance of the door. The user can be identified by a recognition means 39 described later based on a part of the user's body registered in the storage 50 in advance and the imaged third detection data 38a. In the present embodiment, the camera 38b is described as the third detection means, but the third detector is not limited thereto and any other detector may be used as long as means can detect a part of the user's body. Also, in the present embodiment, the face of the user is described as a part of the body, but a part of the body is not limited thereto as long as it can be used for biometric authentication such as voice prints, fingerprints, veins, irises, retinas, palms or the like.

### Flow of Mode Switching

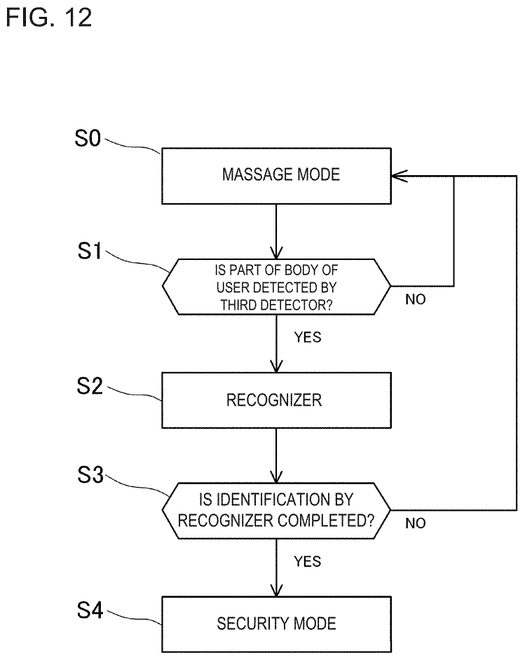

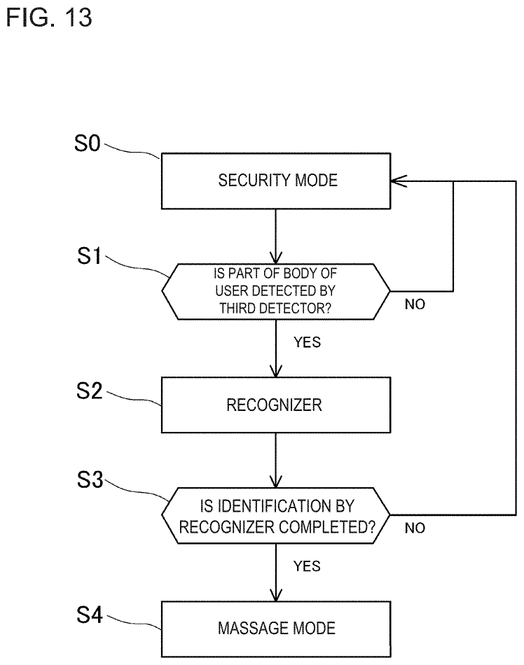

FIG. 12 is a flowchart of first mode switching. FIG. 13 is a flowchart of second mode switching. The mode switching is performed automatically to the massage mode 9c or the security mode 9d by determining the number of persons in the space SP1 where the massage machine 1 is installed based on the third detector 38 provided at the entrance of the space SP1 where the massage machine 1 is installed.

Hereinafter, the first mode switching will be described based on FIG. 12. FIG. 12 is a flowchart for explaining the mode switching automatically performed from the massage mode 9c to the security mode 9d.

The first mode switching is described with an example of a case where a plurality of persons (two persons) that a part (a face) of the user's body is registered in the storage 50 in advance for identifying the user are present in the space SP1 where the massage machine 1 installed and the massage machine 1 is in the massage mode 9c (step S0). When two persons present in the space SP1 where the massage machine 1 is installed go out from the space SP1 where the massage machine 1 is installed, the third detector 38 provided at the entrance of the space SP1 where the massage machine 1 is installed detects a part of the user's body (step S1). In a case where a part of the user's body is not detected, the process returns to step S0, and in a case where a part of the user's body is detected, the process proceeds the recognition means 39 (refer to FIG. 4) that identifies the user based on a part of the user's body registered in the storage 50 in advance and the third detection data 38a detected by the third detector 38 (step S2). Specifically, a part of the user's body is a face and the third detector 38 is the camera 38b. The user is identified based on face data that is the third detection data 38a of the user detected by the camera 38b and face data registered in the storage 50 in advance. The number of persons to be identified by the recognition means 39 can be set by the user. Accordingly, it is possible to identify one to a plurality of persons. Following step S2, the recognition means 39 identifies whether the persons present in the space SP1 where the massage machine 1 is installed go out the space SP1 where the massage machine 1 is installed (step S3). In step S3, in a case where identification is completed that the registered number of persons (two persons) go out the space SP1 where the massage machine 1 is installed, the process proceeds to the security mode 9d (step S4), in a case where the identification is not completed, the process returns to step S0. In step S4, the controller 9 controls the mode switching from the massage mode 9c to the security mode 9d. Accordingly, the user can automatically perform the mode switching without manually performing the mode switching from the massage mode 9c to the security mode 9d.

Hereinafter, the second mode switching will be described based on FIG. 13. FIG. 13 is a flowchart for explaining the mode switching automatically performed from the security mode 9d to the massage mode 9c.

The second mode switching is described with an example of a case where a plurality of persons (two persons) that a part (a face) of the user's body is registered in the storage 50 in advance for identifying the user go out the space SP1 where the massage machine 1 installed and the massage machine 1 is in the security mode 9d (step S0). When one of two persons enters the space SP1 where the massage machine 1 is installed, the third detector 38 provided at the entrance of the space SP1 detects a part of the user's body (step S1). In a case where a part of the user's body is not detected, the process returns to step S0, and in a case where a part of the user's body is detected, the process proceeds the recognition means 39 that identifies the user based on a part of the user's body registered in the storage 50 in advance and the third detection data 38a detected by the third detector 38 (step S2). Specifically, a part of the user's body is a face and the third detector 38 is the camera 38b. The user is identified based on face data that is the third detection data 38a of the user detected by the camera 38b and face data registered in the storage 50 in advance. Following step S2, the recognition means 39 identifies whether the persons outside the space SP1 where the massage machine 1 is installed enter the space SP1 where the massage machine 1 is installed (step S3). In step S3, in a case where identification is completed that one of the registered numbers of persons enters space SP1 where the massage machine 1 is installed from the outside of the space SP1, the process proceeds to the massage mode 9c (step S4), in a case where the identification that the person enters in the space SP1 is not completed, the process returns to step S0. In step S4, the controller 9 controls the mode switching from the security mode 9d to the massage mode 9c. Accordingly, the user can automatically perform the mode switching without manually performing the mode switching from the security mode 9d to the massage mode 9c.

The present invention is not limited to the above embodiment and various modifications can be made by a person skilled in the art.

The present invention can be applied to a security system capable of informing an external terminal of an abnormality in a space where a massage machine is installed, and a massage machine provided including the security system.

The contents of Japanese Patent Application No. 2018-191621 filed on Oct. 10, 2018, including the specification, the claims and the drawings, are incorporated herein by reference in their entirety.

What is claimed is:

1. A security system comprising:
a massage machine; and
an external terminal capable of communicating with the massage machine via a communication network;
wherein the massage machine includes:
a massager that performs massage on a user,
a controller that controls the massager,
a first detector that detects a motion of a human body or an object and generates first detection data,
a storage that stores the first detection data, and
a telecommunicator that connects the controller to the communication network;
the controller includes:
an abnormality determinator that determines presence or absence of an abnormality based on the first detection data in the storage, and
an abnormality notifier that notifies the telecommunicator of the abnormality when the abnormality determinator determines that an abnormality is present.

2. The security system according to claim 1,
wherein the first detector comprises an infrared sensor including a light emitter and a light receiver, and
the light receiver receives light reflected when the light emitter emits light in a predetermined range, and detects a motion of a human body or an object based on a change in a reflected light amount.

3. The security system according to claim 1,
wherein the first detector comprises a camera, and detects the motion by comparing a past image captured by the camera previously with a current image captured by the camera currently.

4. The security system according to claim 1, further comprising:
a first image capturer that captures first image data within a range that the first detector detects;
the storage stores the first image data,
wherein the abnormality notifier notifies the telecommunicator of the first image data when the abnormality determinator determines that the abnormality is present.

5. The security system according to claim 1, further comprising:
a sound outputter that outputs sound,
wherein the controller causes the sound outputter to output sound when the abnormality determinator determines that the abnormality is present.

6. The security system according to claim 1, further comprising:
a second detector that is capable of communicating with the massage machine and detects a motion of a human body or an object in the same space as or a different space from a space where the massage machine is installed and generates second detection data,
the storage stores the second detection data,
wherein the abnormality determinator determines the presence or absence of an abnormality based on the first detection data and/or the second detection data in the storage.

7. The security system according to claim 1,
wherein personal data of one or more persons relating to a part of a user's body for identifying the user is stored in the storage in advance,
the security system further comprises:
a third detector that is capable of communicating with the massage machine, is provided at an entrance of a space where the massage machine is installed, and detects a part of a user's body, the third detector generates third detection data that are stored in the storage, and
a user recognizer that identifies the user based on the personal data stored in the storage and the third detection data stored in the storage,
the massage machine includes a massage mode in which a massage is performed on a user by the massager and a security mode in which the abnormality notifier notifies the external terminal of an abnormality, and
the controller causes the recognizer to determine a number of persons present in the space, and performs control of switching the mode to the massage mode in a case where it is determined that one or more persons exist in the space, and switching the mode to the security mode in a case where it is determined that no person exists in the space.

8. A massage machine comprising:
a massager that performs massage on a user,
a controller that controls the massager,
a first detector that detects a motion of a human body or an object and generates first detection data,
a storage that stores the first detection data, and
a telecommunicator that connects the controller to a communication network that can connect the telecommunicator to a terminal;
wherein the controller includes:
an abnormality determinator that determines presence or absence of an abnormality based on the first detection data in the storage, and
an abnormality notifier that notifies the telecommunicator of the abnormality when the abnormality determinator determines that an abnormality is present.

9. The massage machine according to claim 8,
wherein the first detector comprises an infrared sensor including a light emitter and a light receiver, and
the light receiver receives light reflected when the light emitter emits light in a predetermined range, and detects a motion of a human body or an object based on a change in a reflected light amount.

10. The massage machine according to claim 8,
wherein the first detector comprises a camera, and detects the motion by comparing a past image captured by the camera previously with a current image captured by the camera currently.

11. The massage machine according to claim 8, further comprising:
a first image capturer that captures first image data within a range that the first detector detects;
the storage stores the first image data,
wherein the abnormality notifier notifies the telecommunicator of the first image data when the abnormality determinator determines that the abnormality is present.

12. The massage machine according to claim 8, further comprising:
a sound outputter that outputs sound,
wherein the controller causes the sound outputter to output sound when the abnormality determinator determines that the abnormality is present.

13. The massage machine according to claim 8, further comprising:
a second detector that is capable of communicating with the massage machine and detects a motion of a human body or an object in the same space as or a different space from a space where the massage machine is installed and generates second detection data,
the storage stores the second detection data,
wherein the abnormality determinator determines the presence or absence of an abnormality based on the first detection data and/or the second detection data in the storage.

14. A security system comprising:
the massage machine according to claim 8; and
an external terminal capable of communicating with the massage machine via a communication network.

15. The security system according to claim 14 further comprising:
a third detector that is capable of communicating with the massage machine, is provided at an entrance of a space where the massage machine is installed, and detects a part of a user's body, the third detector generates third detection data that are stored in the storage, and
a user recognizer that identifies the user based on the personal data stored in the storage and the third detection data stored in the storage,
the massage machine includes a massage mode in which a massage is performed on a user by the massager and a security mode in which the abnormality notifier notifies the external terminal of an abnormality, and
the controller causes the recognizer to determine a number of persons present in the space, and performs control of switching the mode to the massage mode in a case where it is determined that one or more persons exist in the space, and switching the mode to the security mode in a case where it is determined that no person exists in the space.
